(19) United States
(12) Patent Application Publication
(10) Pub. No.: US 2006/0047807 A1
(43) Pub. Date: Mar. 2, 2006

(54) Method and system for detecting a network anomaly in a network

(75) Inventors: Antonio Magnaghi, Sunnyvale, CA (US); Takeo Hamada, Cupertino, CA (US)

Correspondence Address: BAKER BOTTS L.L.P., 2001 ROSS AVENUE, SUITE 600, DALLAS, TX, 75201-2980, US

(73) Assignee: Fujitsu Limited

(21) Appl. No.: 10/926,108

(22) Filed: Aug. 25, 2004

(51) Int. Cl. G06F 15/173

(52) U.S. Cl. 709/224

(57) ABSTRACT

A method for detecting a network anomaly in a network includes collecting management information base (MIB) data from the network at an interval and constructing a time series of the collected data. The method also includes decomposing the time series of the collected data in the wavelet domain, constructing an energy plot based on the time series decomposed in the wavelet domain and analyzing the energy plot to determine a sign of a network anomaly event.

### TECHNICAL FIELD OF THE INVENTION

The present invention relates generally to communication networks and, more particularly, to a method and system for detecting a network anomaly in a network.

### BACKGROUND OF THE INVENTION

Network operators are faced, on a daily basis, with complex network anomalies, particularly misconfigurations, that can seriously undermine the performance of the network infrastructure they operate and diminish revenue. Addressing such anomalies can require the development of effective detection technologies capable of promptly isolating such problems. The range of misconfigurations that appear in wide-scale networks is broad and continues to evolve over time as new protocols and applications are developed. Typically, a specific detection algorithm is designed to identify a well-defined misconfiguration.

### SUMMARY OF THE INVENTION

The present invention provides a method and system for detecting a network anomaly in a network that substantially eliminates or reduces at least some of the disadvantages and problems associated with previous methods and systems.

According to a particular embodiment, a method for detecting a network anomaly in a network includes collecting management information base (MIB) data from the network at an interval and constructing a time series of the collected data. The method also includes decomposing the time series of the collected data, constructing an energy plot based on the decomposed time series and analyzing the energy plot to determine a sign of a network anomaly event.

Decomposing the time series of the collected data may comprise decomposing the time series of the collected data in the wavelet domain, and constructing an energy plot may comprise constructing an energy plot based on the time series decomposed in the wavelet domain. Analyzing the energy plot to determine a sign of a network anomaly event may comprise analyzing the energy plot to determine a deviation from linear behavior. The deviation from linear behavior may comprise an abnormal decrease in the energy value relative to the linear behavior. The method may include repeating the collecting MIB data, constructing a time series, decomposing the time series in the wavelet domain, constructing an energy plot and analyzing the energy plot a selected number of times and generating an alarm indicating a network anomaly event if a sign of a network anomaly event is detected a selected threshold of the selected number of times. The network anomaly event may comprise at least one of duplication of IP address space, packet filtering misconfiguration, permanent routing loop and distributed denial of service attack. Collecting MIB data from the network may comprise collecting packet count statistics.

In accordance with another embodiment, a system for detecting a network anomaly in a network comprises a network device that includes a memory operable to collect management information base (MIB) data from the network at an interval and a controller coupled to the memory. The controller is operable to construct a time series of the collected data, decompose the time series of the collected data in the wavelet domain, construct an energy plot based on the time series decomposed in the wavelet domain and analyze the energy plot to determine a sign of a network anomaly event.

Technical advantages of particular embodiments include a method that is able to detecting multiple types of network anomalies and misconfigurations in a network, including loops, IP duplication addresses, distance-vector (DV) routing state corruption, exceeding of maximum transmission unit (MTU), black hole and misconfigured packet filtering. Thus, particular embodiments can detect a significant portion of the network anomaly space, including future misconfigurations, with limited network reconfiguration since MIB data may be used in the detection process. Accordingly, time and expense associated with implementing network anomaly detection functionalities are reduced as the need for detection components for each type of network anomaly may be reduced. Moreover, particular embodiments analyze TCP behavior and retransmission time-out (RTO) events which are consistently adhered to by network device manufactures. This ensures that particular embodiments implementing network anomaly detection are applicable to a broad set of products from different manufacturers.

Other technical advantages of the present invention will be readily apparent to one skilled in the art from the following figures, descriptions, and claims. Moreover, while specific advantages have been enumerated above, various embodiments may include all, some or none of the enumerated advantages.

### BRIEF DESCRIPTION OF THE DRAWINGS

For a more complete understanding of the present invention and its advantages, reference is now made to the following description, taken in conjunction with the accompanying drawings, in which:

FIG. 1 illustrates a communication system for detecting a network anomaly in a network, in accordance with a particular embodiment;

FIG. 2 is a block diagram illustrating exemplary functional components of the analysis device of FIG. 1; and

FIG. 3 is a flowchart illustrating a method for detecting a network anomaly in a network, in accordance with a particular embodiment.

### DETAILED DESCRIPTION

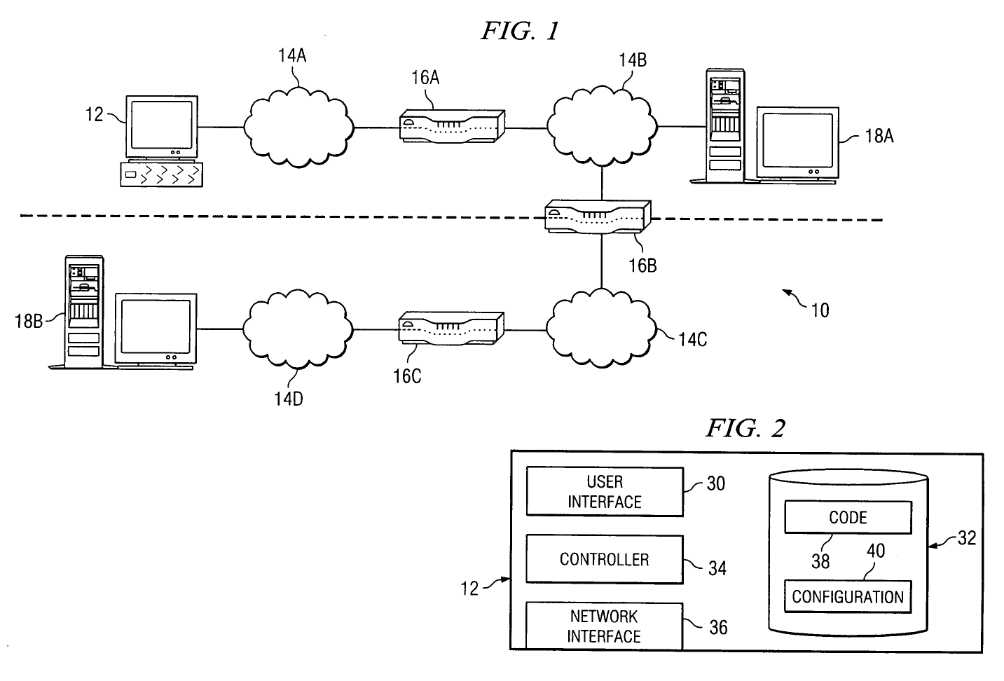

FIG. 1 illustrates a communication system 10 in accordance with a particular embodiment. Communication system 10 includes an analysis device 12, network segments 14, routers 16 and servers 18 and may comprise any suitable communication networks. Communication system 10 may comprise, for example, networks of major Tier-I providers or national internet service providers or public or private local area networks (LANs) and wide area networks (WANs). In general, analysis device 12 provides analysis of network traffic to diagnose network anomalies, such as misconfigurations, within system 10 that can degrade network performance. More specifically, analysis device 12 may enable detection of misconfigurations and network anomalies between linked devices within communication system 10. According to particular embodiments, analysis device 12 collects traffic data and can detect network anomalies by analyzing characteristics of the collected traffic data. Analysis device 12 can detect a family of network anomalies in any of a variety of network types. Such network anomalies may include, for example, misconfigurations such as loops, IP duplication addresses, distance-vector (DV) routing state corruption, exceeding of maximum transmission unit (MTU), black hole and misconfigured packet filtering.

Analysis device 12 represents any suitable network equipment, including appropriate controlling logic, capable of coupling to other elements and communicating using packet based standards. For example, analysis device 12 may comprise a general purpose computer, a router, a specially designed component or other suitable network equipment. Analysis device 12 provides for analysis of network traffic data to detect network anomalies.

Similar to analysis device 12, each server 18 represents network equipment, including any appropriate controlling logic, for coupling to other network equipment and communicating using packet based communication protocols to provide various services. Servers 18 may, for example, provide network accessible services for other elements within system 10. These services could include any number of features, such as web hosting, data management, processing or other suitable services. In certain circumstances, one or more servers 18 may support diagnosis functions similar to those provided by analysis device 12, or for cooperation with the diagnosis performed by analysis device 12.

In the illustrated embodiment, analysis device 12 and servers 18 are interconnected by communications equipment that includes network segments 14 and routers 16. Each network segment 14 represents any suitable collection and arrangement of components and transmission media supporting packet based transmission control protocol (TCP) communications. The use of the term packet should be understood to contemplate any suitable segmentation of data, such as packets, frames, or cells. A specific network segment 14 may include any number of interconnected switches, hubs or repeaters. Routers 16 permit network traffic to flow between network segments 14.

Analysis device 12 collects and analyzes network traffic to diagnose a family of network anomalies that share common characteristics that include general performance metrics. These network anomalies can be identified by detecting packet loss at the beginning of a TCP connection. When a first packet emitted by a node at the beginning of a TCP connection is lost, the node will wait for a reply from the destination node. If no reply is received (indicating packet loss), then the packet is retransmitted again. Thus, when a packet loss occurs a retransmission time-out (RTO) takes place. If no reply is obtained within, for example, three seconds after the original transmission, the same exact packet is sent out again. Assuming an anomaly exists in the network, the packet that is retransmitted will again be lost. If no reply is obtained after six seconds, a second retransmission occurs. If no reply is obtained after twelve seconds, a third retransmission occurs and so on. Particular embodiments identify early RTO events (EREs) which utilize default RTO values. These default RTO values are standardized and consistently implemented in TCP/IP protocol. Thus, retransmission events incurred in the opening phase of TCP connections generate network traffic with well-defined characteristics and following a deterministic pattern that may be insensitive to module implementations and end-to-end path properties.

Particular embodiments implement, for example through analysis device 12, a detection algorithm, further discussed below, capable of isolating misconfigured components imbedded in aggregated traffic. Some embodiments use wavelet analysis of time series management information base (MIB) data, such as packet count statistics, to decompose the energy of the input signal at different resolution levels. Other embodiments may use other spectral analysis approaches, such as the windowed Fourier transform. EREs in many cases result in the presence of dips at precise resolution levels. Particular embodiments utilize a procedure to analyze and recognize these energy level dips to infer the presence of anomalies.

In operation, traffic data is periodically collected by analysis device 12 from network devices, such as routers 16. In particular embodiments, traffic data may be collected from one or more network devices every second. For example, with respect to a particular router, data indicating the number of packets coming through an interface of the router may be collected periodically. From the collected traffic data of the router, a time series is constructed that identifies the number of packets that go through an interface of the router over time. The packets of this times series may include packets from healthy traffic and packets from misconfigured, or unhealthy, traffic. Once the time series is constructed, it is analyzed to determine whether it contains an anomaly. In particular embodiments, such analysis may be made through wavelet spectral analysis of the time series traffic data.

Many types of network anomalies can cause the spectral energy plot of collected data to deviate from the linear behavior of healthy traffic. These types of events make the energy plot show a dip at certain energy levels. Such a dip may thus be a fingerprint of a retransmission event and therefore a sign of packet loss indicating an anomaly in the network.

Particular types of anomalies or misconfigurations that can be detected through a loss of packet at the beginning of a TCP connection include duplication of IP address space, packet filtering misconfiguration, permanent routing loop and TCP-SYN flood distributed denial of service (D-DoS) attacks. Each of these target anomalies share common properties that allow such detection. Duplication of IP address space is frequently observed in medium-to wide-scale networks. The misconfiguration is introduced when a new sub-network S-N₂ is added to a pre-existent network N₁ or when, for maintenance reasons, the address space assigned to S-N₂ is altered. Inadvertently, S-N₂ address space overlaps with the address space of a different sub-network S-N₁ in N₁. This misconfiguration appears to be caused by: (a) lack of coordination among different divisions administering separate portions of the same networking infrastructure or (b) lack of up-to-date information about recent modifications to certain network portions (e.g., incomplete network diagrams, stale configuration information, etc.). Such a misconfiguration interferes with the internal routing state of the network. In the case where a DV protocol is used, nodes in N₁ close to the misconfiguration point S-N₂ will change their routing state. DV information exchange reveals the existence of a shorter path to a certain prefix, namely the address space of S-N₁. Once the routing state of N₁ has converged, let M(S-N₂) be the set of routers in N₁ the state of which is altered in response to such a misconfiguration. Packets addressed to S-N₁ that reach a node in M(S-N₂) will be routed towards S-N₂, where they typically are discarded. Conversely, packets addressed to S-N, which do not reach a node in M(S-N₂) will be properly forwarded to S-N₁. Depending on the particular position inside network N₁, the problem can be easily observed or completely transparent to typical monitoring activity. This increases the complexity of troubleshooting compared to misconfigurations that result in complete outages. The TCP flows affected by the misconfiguration are not able to complete the three-way handshake required to open a new connection. Other misconfiguration cases may also be possible involving duplication of IP address space.

Packet filtering misconfiguration is another target anomaly. Packet filtering is a common practice in most networks and aims at improving security and integrity. Generally, packet-filtering misconfigurations can result in: (a) unwanted packet drop, if the filter is excessively restrictive or (b) leaking of undesired packets if the filter configuration is too permissive. Excessively restrictive filtering misconfigurations can typically be attributed to several factors: (a) most supported filtering specification formats are very restrictive in their semantic which requires administrators to write cumbersome rules; (b) filtering rules are typically packet-based, however business-centric filtering requirements are flow-oriented; and (c) filtering tools impose an implicit rule-processing order that frequently is overlooked when configuration changes are made. There are several filtering misconfigurations that discard all packets to/from a certain address space. Such situations affect TCP connection establishment in a manner similar to other types of target misconfigurations. In these situations, the TCP handshake cannot complete, and RTO-based retransmissions or EREs occur.

Permanent routing loops are additional types of target anomalies that present serious problems, because they cause elevated bandwidth utilization and packet losses. Typically, layer-3 loops are categorized as transient or permanent. Transient loops naturally occur during propagation of routing changes and disappear once convergence is reached. Some permanent routing loops are induced by erroneous static configurations of routes affecting certain prefixes. Other permanent routing loops are due to corruption of DV routing state. One specific anomaly appears as the interaction of plausible configuration choices in combination with misconfiguration of packet filtering. The concomitance of events is such that routing information leaks from a network N₁ into an adjacent network N₂. The routing state of N₂ is altered in such a manner that packets sourcing from N₁ are routed by N₂ back to N₁, typically through an interconnection point different from the one where packets from N₁ entered N₂ initially. Such a misconfiguration may not be frequent, but it is very detrimental in terms of network performance. In loop-related misconfigurations, packets affected by the problem loop are eventually dropped because their TTL value expires. TCP connections initiated by hosts affected by the problem will not be able to complete the transaction, and ERE retransmissions occur.

Another type of target anomaly is a D-Dos attack. The purpose of a D-DoS attack is to harm a specific target in such a manner that the service(s) provided by the target becomes unavailable to legitimate users. Different mechanisms can be exploited by the attacker. The TCP-SYN flood attack is a quite common practice and causes network anomalies that manifest important analogies with other types of misconfigurations described. The attacker typically uses a set of compromised hosts from which spoofed TCP-SYN packets are generated towards a target. The target produces TCP-SYN-ACK packets destined to the spoofed addresses of the initial TCP-SYNs. TCP-SYN-ACKs from the target are, thus, lost and half-opened TCP connections saturate the incoming request queue. Additionally, subsequent incoming TCP-SYN packets are discarded when legitimate clients try to open a new connection with the target. As a result, service is denied. RTO-based retransmissions take place from the target's side (lost TCP-SYN-ACKs in response to spoofed packets) and from the clients' side (lost TCP-SYN due to overflow of queue of incoming requests at the target). The latter group of TCP flows is numerically more significant. The more successful a D-DoS attack, the more clients' early RTO retransmissions will be present in the network.

As indicated above, the presence of EREs is an anomalous behavior shared among misconfigurations targeted by particular embodiments. Because packet loss affects the opening phase of a new TCP connection, RTO timers utilize default values. This introduces well-defined correlations in misconfigured flows at precise time scales dictated by the exponential back-off RTO management algorithm. Thus, if a packet is observed in the three-way handshake that subsequently is lost, then the same packet should be observed again after 3·2^{k} seconds (k=0, 1, 2, . . . ). In principle, if the retransmission sequence were an infinite series, the traffic pattern would produce a power-law ON-OFF behavior known as pseudo self-similarity. However, in practice, the sequence of retransmission events is a finite sequence, and the number of retransmission attempts is limited.

Typically, TCP/IP module implementations will attempt resending a lost packet a limited number of times. The maximum number of attempts (k_{MAX}) may vary in various implementations. Additionally, k_{MAX} can depend on the state of the TCP connection when the loss occurs (e.g., connection opening vs. data exchange). k_{MAX} is typically lower during the handshake stage. For Windows-based hosts in the default configuration, k_{MAX}=1 for the loss of a packet within the handshake phase. In the case of Linux O/S, k_{MAX}=4. In addition, end-user tolerance to low responsiveness is typically limited to about 8-14 seconds. Hence, the TCP module may be able to resend the lost packet only few times before the connection is terminated by the application layer.

Typically, early RTO retransmission patterns, or EREs, are repeated uniformly in all TCP flows affected by a misconfiguration. This would not necessarily be the case if RTO events occurred at a later point inside the TCP connection. In fact, RTO timers in each flow would be regulated by the RTT experienced by each connection individually. RTT values typically manifest high dispersion due to the static and dynamic characteristics of a particular end-to-end connection. RTO retransmissions in the handshake phase are typically insensitive to such aspects as no RTT measurement is available. Additionally, as default initialization values of the RTO management algorithm are standardized, dependency on a specific TCP/IP module implementation is not as much of a concern in this phase of the connection.

Particular embodiments may utilize the algorithm described below to detect a network anomaly or misconfiguration event through a local minimum of an energy plot. Let {X_{o,r}} (0≦r≦2^{M}−1; MεN) be the discrete input signal to analyze for anomaly detection. The first subscript in {X_{0,r}} denotes the aggregation level. The second subscript identifies a specific sample at a given time and aggregation level. Increasing values of the aggregation level correspond to coarser resolutions. The signal samples are uniformly spaced in time. ΔT is the time interval between two consecutive samples at the finest resolution available. The algorithm presently discussed utilizes a Haar-filter based representation of the signal. Two vector series are produced. They are known as the aggregated signals {X_{q,r}} (1) and the details {d_{q,r}} (2) (1≦q≦M):

$$\{ \begin{matrix}{X}_{q , r} = \frac{1}{\sqrt{2}} ( {X}_{q - 1 , 2 r} + {X}_{q - 1 , 2 r + 1} ) & & & & & & & & & & & & & ( 1 ) \\ {d}_{q , r} = \frac{1}{\sqrt{2}} ( {X}_{q - 1 , 2 r} - {X}_{q - 1 , 2 r + 1} ) & & & & & & & & & & & & & ( 2 )\end{matrix}$$

Successively, the energy content E_{q} of the q-th resolution level is computed:

$${E}_{q} = \frac{1}{{2}^{M - q}} {\sum }_{r = 0}^{{2}^{M - q} - 1} {\vert {d}_{q , r} \vert}^{2} \qquad ( 3 )$$

The energy plot is the diagram of log₂(E_{q}) as a function of the resolution level q. The detection algorithm uses the energy plot for determining general aspects of the scaling behavior of the underlying time-series. Asymptotically, the behavior of the energy function is expected to be linear in q for self-similar processes over a broad variety of packet-switched networks:
log₂ (E_{q})≈(2H−1)q+b (4)

In equation (4), H is the Hurst parameter and b is a constant. As ½<H<1, the slope of the straight line in equation (4) is 0<(2H−1)<1. RTO events alter the linear behavior of the energy function over a precise range of aggregation levels. In particular modeling, consecutive RTO events are separated by 3·2^{k} seconds (0≦k≦k_{MAX}), being k_{MAX} a finite and generally small value. In the remainder, kMAX is assumed to equal 2.

If ΔT=3·2^{-u} sec (u≧0) is the signal sampling rate, the energy function of the signal for early RTO retransmissions manifests a local dip over the wavelet aggregation levels {u+1, u+2, u+3}. The signal consists of the initial packet, followed by three subsequent retransmissions. The signal {X_{o,r}} can be represented in terms of this binary function: δ₀(t)+δ_{3·2k}(t) (0≦k_{MAX}), where δₖ(t)=1 if t=k, δₖ(t)=0 otherwise. In virtue of equation (1), the signal at the aggregation level u is:

$${X}_{u , 0} = {X}_{u , 1} = {X}_{u , 3} = {X}_{u , 7} = {2}^{- \frac{u}{2}} \qquad ( 5 )$$

X_{u,2}=X_{u,4}=x_{u,5}=X_{i,6}=0 (6)
In virtue of equations (2) and (3), the energy content of the details at aggregation levels {u+1, u+2, u+3} is:

$${E}_{u + 1} = \frac{{2}^{- u}}{4} ; {E}_{u + 2} = \frac{{2}^{- u}}{4} ; {E}_{u + 3} = \frac{{2}^{- u}}{2} \qquad ( 7 )$$

The plot of the energy function and its shape (local minimum) in a neighborhood of aggregation levels {u+1, u+2, u+3} is illustrated below. This illustration also contrasts the early RTO-based signal energy function (solid line) with the linear behavior predicted by equation (4) (dashed line).

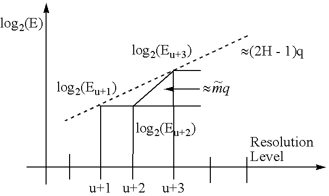

$$\tilde{m} = \frac{{log}_{2} ( {E}_{u + 3} ) - {log}_{2} ( {E}_{u + 2} )}{( u + 3 ) - ( u + 2 )} = {log}_{2} ( \frac{{2}^{- u}}{2} ) - {log}_{2} ( \frac{{2}^{- u}}{4} ) = 1$$

In a typical deployment scenario, multiple healthy TCP flows (noise to anomaly detection) will be multiplexed with misconfigured flows (for which the Locality Property holds). The described analysis algorithm detects the presence of a misconfigured component embedded in aggregated traffic by studying the energy function shape over an aggregation range inclusive of the interval [u+1, u+3]. To locate a dip (local minimum) in the aggregation interval of interest, the energy function is approximated in terms of the least-squares parabola: y=β₀+β₁x+β2x². The unknowns {β₀, β₁, β₂} are subject to the following conditions:

$$\begin{matrix}\frac{\partial }{\partial {β}_{k}} ( {\sum }_{i = u}^{u + 4} {( {log}_{2} ( {E}_{i} ) - {β}_{0} - {β}_{1} i - {β}_{2} {i}^{2} )}^{2} ) = 0 , & & 0 \leq k \leq 2\end{matrix} \qquad ( 8 )$$

Let {\tilde{β}₀, \tilde{β}₁, \tilde{β}₂} be the solution to equation set (8). Let V be the vertex of y:

$$V = ( {V}_{q} , {V}_{{log}_{2} ( E )} ) = ( - \frac{{\tilde{β}}_{1}}{2 {\tilde{β}}_{2}} ; {\tilde{β}}_{0} - \frac{{\tilde{β}}_{1}^{2}}{4 {\tilde{β}}_{2}} ) \qquad ( 9 )$$

If V satisfies relationships (10) and (11), the detection algorithm marks the time-series as containing an energy dip and, therefore, a sign of anomaly is detected.

$$\{ \begin{matrix}{\tilde{β}}_{2} > 0 & & & & & & & & & & & & & & ( 10 ) \\ ( u + 1 ) \leq ( - \frac{{\tilde{β}}_{1}}{2 {\tilde{β}}_{2}} ) \leq ( u + 3 ) & & & & & & & & & & & & & & ( 11 )\end{matrix}$$

Relationship (10) requires that V is a local minimum. Relationship (11) implies that the abscissa of V falls in the energy level range of interest. This described detection algorithm implemented in particular embodiments aggregates n measurements into a sample Sₙ. Let m (m≦n) be the number of measurements in Sn marked as anomalous by relationships (10) and (11). A threshold γ may be used to trigger an alarm if (m/n)≧γ.

The preceding description provides detailed mathematical formulas for statistical processing of collected time series data for network anomaly detection. However, as noted above, system 10 contemplate analysis device 12 using any appropriate techniques and calculations for detecting potential network anomalies, including misconfigurations. Regardless of the techniques used, once a network anomaly is detected, analysis device 12 can report the network anomaly and/or perform additional tests to further isolate the location of the network anomaly.

FIG. 2 is a block diagram illustrating exemplary functional elements for analysis device 12. In the embodiment illustrated, analysis device 12 includes a user interface 30, a memory 32, a controller 34 and a network interface 36. In general, analysis device 12, as previously discussed, provides for the detection of multiple types of network anomalies in a network.

User interface 30 provides for interactions with users of analysis device 12. For example, user interface 30 may include a display, keyboard, keypad, mouse and/or other suitable elements for presenting information to and receiving input from users. Memory 32 provides for storage of information for use by analysis device 12. In the embodiment illustrated, memory 32 includes code 38 and configuration information 40. Code 38 includes software, source code and/or other appropriate controlling logic for use by elements of analysis device 12. For example, code 38 may include logic implementing some or all operations for analyzing a data path. Configuration information 40 includes start-up, operating and other suitable settings and configurations for use by analysis device 12. For example, configuration information 40 may identify IP addresses of remote targets, user settings, thresholds, and/or other suitable information for use during operation.

Network interface 36 supports packet based communications with other network equipment. For example, network interface 36 may support the transmission and receipt of packets using any appropriate communication protocols. Controller 34 controls the management and operation of analysis device 12. For example, controller 34 may include one or more microprocessors, programmed logic devices or other suitable elements executing code 38 to control the operation of analysis device 12.

During operation, the elements of analysis device 12 operate to analyze data collected from components of system 10 to identify network anomalies. For example, controller 34 may execute code 38 based upon configuration information 40 to control the operation of network interface 36. Controller 34 may then analyze received network operational data to detect signs of network anomalies. Upon detecting a sign of a network anomaly, controller 34 may alert a user using user interface 30 or may otherwise generate an alarm indicating a network anomaly. In other cases, the alarm may be generated once a threshold level of anomaly signs have been detected. In some cases, the generation of an alarm as a result of analysis revealing a detection of a network anomaly may be based on statistical inference, neural networks, spacial and/or time event correlation or other methods. The particular embodiment illustrated provides example modules for implementing broad functionality within analysis device 12.

However, while the embodiment illustrated and the preceding description focus on a particular embodiment of analysis device 12 that includes specific elements, system 10 contemplates analysis device 12 having any suitable combination and arrangement of elements for providing analysis of collected data and for detecting network anomalies. Thus the modules and functionalities described may be combined, separated or otherwise distributed among any suitable functional components. Moreover, while shown as including specific functional elements, system 10 contemplates analysis device 12 implementing some or all of its functionality using logic encoded in media, such as software or programmed logic devices. Additionally, while shown as a dedicated analysis device 12, system 10 contemplates the analysis functionality of device 12 being implemented by any suitable components within system 10. Thus, for example, elements such as routers 16 or servers 18 may implement various network analysis functions, such as network anomaly detection, as described with respect to analysis device 12.

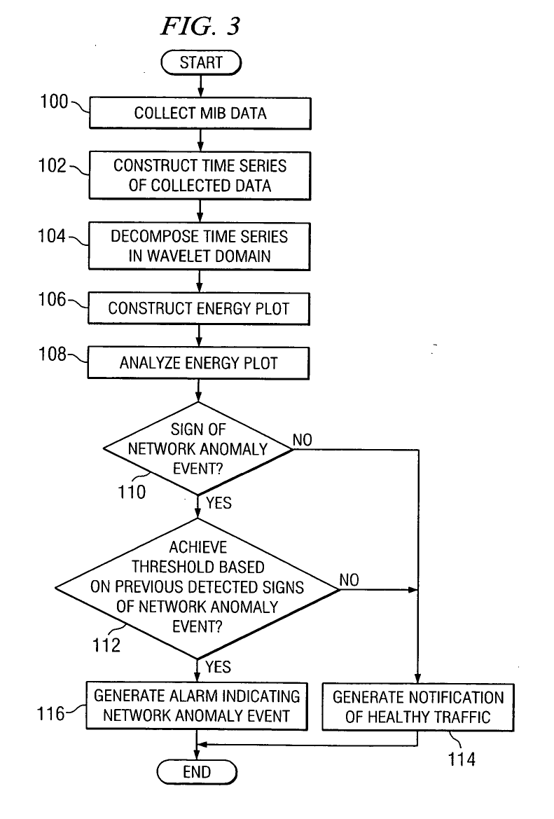

FIG. 3 is a flowchart illustrating a method for detecting a network anomaly, such as a misconfiguration, in a network, in accordance with a particular embodiment. In particular embodiments, network anomaly events targeted for detection may include duplications of IP address space, packet filtering misconfigurations, permanent routing loops and distributed denial of service attacks. The method begins at step 100 where MIB data is collected from one or more network devices. MIB allows one to query a network device and retrieve how many packets have gone through device interface since the last query. The MIB data may be collected at an interval, for example, every second or particular number of seconds. At step 102, a time series of the MIB data measurements is constructed. The time series may identify, for example, the number of packets going through a device interface over time. These packets may include both healthy and unhealthy traffic.

At step 104, the time series is decomposed in the wavelet domain. Such decomposition may use the Harr wavelet function in particular embodiments. It should be understood that other embodiments may use spectral analysis approaches other than wavelets, such as the windowed Fourier transform. At step 106, an energy plot is constructed based on the time series in the wavelet domain. At step 108, the energy plot is analyzed to determine, at step 110, whether it includes a sign of a network anomaly event. In particular embodiments, a sign of a network anomaly event may comprise a dip or abnormal decrease in the energy value of the plot, as healthy traffic typically maps to linear behavior on the energy plot. The interpolation may be carried out over a certain range of aggregation levels, and if a minimum of parabola falls within the range then there may be a decrease in the energy function in the considered range. This decrease may be a sign of a network anomaly event.

If a sign of a network anomaly event is detected, the method may proceed to step 112, where it is determined whether a threshold level of signs of network anomaly events have been detected. This determination uses past data that may indicate a network anomaly event. A threshold level may comprise any suitable level or percentage, such as at least three detections of signs of network anomaly events out of four consecutive energy plots analyzed. If the threshold level is achieved, an alarm may be generated indicating a network anomaly event at step 116. The extra intelligence layer of requiring a threshold level to be achieved prior to generating the alarm avoids false alarms of network anomaly events that may, for example, be based on noise or other non-network anomaly events that may generate a dip in the energy plot. Thus, a group of measurements is analyzed to reach a more meaningful decision. Particular embodiments may not include the additional threshold determination and may merely generate an alarm based on one sign of a network anomaly event. In other embodiments, the generation of an alarm as a result of analysis revealing a detection of a network anomaly may be based on statistical inference, neural networks, spacial and/or time event correlation or other methods.

If there is no sign of a network anomaly event or, if a threshold level is used, the sign of the network anomaly event does not reach such a level then at step 114 a notification of healthy traffic may be generated. Particular steps may be repeated continuously over time, particularly if one seeks consecutive measurements to determine whether a threshold level of network anomaly indicators have been detected.

Some of the steps illustrated in FIG. 3 may be combined, modified or deleted where appropriate, and additional steps may also be added to the flowchart. Additionally, steps may be performed in any suitable order without departing from the scope of the invention.

Technical advantages of particular embodiments include a method that is able to detecting multiple types of network anomalies in a network, including loops, IP duplication addresses, DV routing state corruption, exceeding of MTU, black hole and misconfigured packet filtering. Thus, particular embodiments can detect a significant portion of the network anomaly space, including future misconfigurations, with limited network reconfiguration since MIB data may be used in the detection process. Accordingly, time and expense associated with implementing network anomaly detection functionalities are reduced as the need for detection components for each type of network anomaly may be reduced. Moreover, particular embodiments analyze TCP behavior and RTO events which are consistently adhered to by network device manufactures. This ensures that particular embodiments implementing network anomaly detection are applicable to a broad set of products from different manufacturers.

Although the present invention has been described in detail with reference to particular embodiments, it should be understood that various other changes, substitutions, and alterations may be made hereto without departing from the spirit and scope of the present invention. For example, although the present invention has been described with reference to a number of elements and components illustrated in FIGS. 1 and 2, and such elements and components may be combined, rearranged or positioned in order to accommodate particular routing architectures or needs. In addition, any of these elements or components may be provided as separate external elements or components where appropriate. The present invention contemplates great flexibility in the arrangement of these elements as well as their internal components.

Numerous other changes, substitutions, variations, alterations and modifications may be ascertained by those skilled in the art and it is intended that the present invention encompass all such changes, substitutions, variations, alterations and modifications as falling within the spirit and scope of the appended claims.

What is claimed is:

1. A method for detecting a network anomaly in a network, comprising:
collecting management information base (MIB) data from the network at an interval;
constructing a time series of the collected data;
decomposing the time series of the collected data;
constructing an energy plot based on the decomposed time series; and
analyzing the energy plot to determine a sign of a network anomaly event.

2. The method of claim 1, wherein:
decomposing the time series of the collected data comprises decomposing the time series of the collected data in the wavelet domain; and
constructing an energy plot based on the decomposed time series comprises constructing an energy plot based on the time series decomposed in the wavelet domain.

3. The method of claim 2, wherein analyzing the energy plot to determine a sign of a network anomaly event comprises analyzing the energy plot to determine a deviation from linear behavior.

4. The method of claim 3, wherein the deviation from linear behavior comprises an abnormal decrease in the energy value relative to the linear behavior.

5. The method of claim 1, further comprising generating an alarm if a sign of a network anomaly event is detected.

6. The method of claim 2, further comprising:
repeating the collecting MIB data, constructing a time series, decomposing the time series in the wavelet domain, constructing an energy plot and analyzing the energy plot a selected number of times; and
generating an alarm indicating a network anomaly event if a sign of a network anomaly event is detected a selected threshold of the selected number of times.

7. The method of claim 6, further comprising generating a notification of healthy traffic if a sign of a network anomaly event is not detected the selected threshold of the selected number of times.

8. The method of claim 2, wherein decomposing the time series of the collected data in a wavelet domain comprises decomposing the time series of the collected data using the Harr wavelet function.

9. The method of claim 1, wherein the network anomaly event comprises at least one of duplication of IP address space, packet filtering misconfiguration, permanent routing loop and distributed denial of service attack.

10. The method of claim 1, wherein collecting MIB data from the network comprises collecting packet count statistics.

11. A system for detecting a network anomaly in a network comprising a network device comprising:
a memory operable to collect management information base (MIB) data from the network at an interval; and
a controller coupled to the memory, the controller operable to:
construct a time series of the collected data;
decompose the time series of the collected data;
construct an energy plot based on the decomposed time series; and
analyze the energy plot to determine a sign of a network anomaly event.

12. The system of claim 11, wherein:
a controller operable to decompose the time series of the collected data comprises a controller operable to decompose the time series of the collected data in the wavelet domain; and
a controller operable to construct an energy plot based on the decomposed time series comprises a controller operable to construct an energy plot based on the time series decomposed in the wavelet domain.

13. The system of claim 12, wherein a controller operable to analyze the energy plot to determine a sign of a network anomaly event comprises a controller operable to analyze the energy plot to determine a deviation from linear behavior.

14. The system of claim 13, wherein the deviation from linear behavior comprises an abnormal decrease in the energy value relative to the linear behavior.

15. The system of claim 11, wherein the controller is further operable to generate an alarm if a sign of a network anomaly event is detected.

16. The system of claim 12, wherein the controller is further operable to:
repeat the collecting MIB data, constructing a time series, decomposing the time series in the wavelet domain, constructing an energy plot and analyzing the energy plot a selected number of times; and
generate an alarm indicating a network anomaly event if a sign of a network anomaly event is detected a selected threshold of the selected number of times.

17. The system of claim 16, wherein the controller is further operable to generate a notification of healthy traffic if a sign of a network anomaly event is not detected the selected threshold of the selected number of times.

18. The system of claim 12, wherein a controller operable to decompose the time series of the collected data in a wavelet domain comprises a controller operable to decompose the time series of the collected data using the Harr wavelet function.

19. The system of claim 11, wherein the network anomaly event comprises at least one of duplication of IP address space, packet filtering misconfiguration, permanent routing loop and distributed denial of service attack.

20. The system of claim 11, wherein a memory operable to collect MIB data from the network comprises a memory operable to collect packet count statistics.

21. Software embodied in a computer readable medium, the computer readable medium comprising code operable to:
collect management information base (MIB) data from the network at an interval;
construct a time series of the collected data;
decompose the time series of the collected data;
construct an energy plot based on the decomposed time series; and
analyze the energy plot to determine a sign of a network anomaly event.

22. The medium of claim 21, wherein:
code operable to decompose the time series of the collected data comprises code operable to decompose the time series of the collected data in the wavelet domain; and
code operable to construct an energy plot based on the decomposed time series comprises code operable to construct an energy plot based on the time series decomposed in the wavelet domain.

23. The medium of claim 22, wherein code operable to analyze the energy plot to determine a sign of a network anomaly event comprises code operable to analyze the energy plot to determine a deviation from linear behavior.

24. The medium of claim 23, wherein the deviation from linear behavior comprises an abnormal decrease in the energy value relative to the linear behavior.

25. The medium of claim 21, wherein the code is further operable to generate an alarm if a sign of a network anomaly event is detected.

26. The medium of claim 22, wherein the code is further operable to:
repeat the collecting MIB data, constructing a time series, decomposing the time series in the wavelet domain, constructing an energy plot and analyzing the energy plot a selected number of times; and
generate an alarm indicating a network anomaly event if a sign of a network anomaly event is detected a selected threshold of the selected number of times.

27. The medium of claim 26, wherein the code is further operable to generate a notification of healthy traffic if a sign of a network anomaly event is not detected the selected threshold of the selected number of times.

28. The medium of claim 22, wherein code operable to decompose the time series of the collected data in a wavelet domain comprises code operable to decompose the time series of the collected data using the Harr wavelet function.

29. The medium of claim 21, wherein the network anomaly event comprises at least one of duplication of IP address space, packet filtering misconfiguration, permanent routing loop and distributed denial of service attack.

30. The medium of claim 21, wherein code operable to collect MIB data from the network comprises code operable to collect packet count statistics.

31. A method for detecting a misconfiguration in a network, comprising:
collecting management information base (MIB) data from the network at an interval, the data comprising packet count statistics;
constructing a time series of the collected data;
decomposing the time series of the collected data in the wavelet domain using the Harr wavelet function;
constructing an energy plot based on the time series decomposed in the wavelet domain;
analyzing the energy plot to determine a sign of a misconfiguration event, wherein a sign of a misconfiguration event comprises a deviation from linear behavior in the energy plot;
repeating the collecting MIB data, constructing a time series, decomposing the time series in the wavelet domain, constructing an energy plot and analyzing the energy plot a selected number of times;
generating an alarm indicating a misconfiguration event if a sign of a misconfiguration event is detected a selected threshold of the selected number of times; and
wherein the misconfiguration event comprises at least one of duplication of IP address space, packet filtering misconfiguration, permanent routing loop and distributed denial of service attack.
